(19) United States
(12) Patent Application Publication
(10) Pub. No.: US 2026/0277584 A1
(43) Pub. Date: Sep. 17, 2026

(54) UPDATE SYSTEM, COMPUTER IMPLEMENTED UPDATE METHOD, AND NON-TRANSITORY RECORDING MEDIUM

(71) Applicant: NEC Communication Systems, Ltd., Tokyo (JP)

(72) Inventor: Stefan AUST, Tokyo (JP)

(73) Assignee: NEC Communication Systems, Ltd., Tokyo (JP)

(21) Appl. No.: 19/168,842

(22) PCT Filed: Mar. 22, 2024
(86) PCT No.: PCT/JP2024/011422

§ 371 Date: Sep. 25, 2025

(30) Foreign Application Priority Data
Apr. 3, 2023 (JP) 2023-059771

(51) Int. Cl. G06F 8/65; G06F 16/25

(52) U.S. Cl. CPC G06F 8/65; G06F 16/258

(57) ABSTRACT

This update system determines whether the data format of moving-body device data is a predetermined data format, and, in cases where it is determined that the data format of the moving-body device data is not the predetermined data format, corrects the data format of the moving-body device data to the predetermined data format. The update system extracts feature information relating to the moving-body device from moving-body device data in the predetermined data format, and estimates the state of the moving-body device using the feature information. The update system calculates an optimized parameter used by each control device on the basis of the moving-body device data and the state information, and updates the parameter.

### TECHNICAL FIELD

The present invention relates to an update system, an update method, an update program, and an information processing device that update parameters used by a plurality of control devices provided in a moving-body device such as a vehicle.

### BACKGROUND ART

In the related arts, various techniques for collecting a diagnosis result from a moving-body device such as a vehicle have been proposed. As an example of such a technique, a failure diagnosis system disclosed in PTL 1 extracts and outputs data of a diagnosis result by a diagnosis program available for diagnosis of vehicles of a plurality of manufacturers according to a classification selected by a user.

### CITATION LIST

### Patent Literature

PTL 1: Japanese Unexamined Patent Application Publication No. 2021-96149

### SUMMARY OF INVENTION

### Technical Problem

However, the failure diagnosis system disclosed in PTL 1 has a problem that, in a case where a moving-body device includes a plurality of control devices and a plurality of pieces of data provided by the moving-body device do not have a common data format, optimized parameters used by each of the control devices cannot be updated.

In view of the above-described problems, an object of the present disclosure is to provide an update system, an update method, an update program, and an information processing device capable of updating an optimized parameter to be used by each of a plurality of control devices even in a case where the moving-body device includes a plurality of control devices and a plurality of pieces of data provided by the moving-body device do not have a common data format.

### Solution to Problem

An update system according to the present disclosure includes,
a data format determination means for determining whether a data format of moving-body device data that is data related to a moving-body device provided from the moving-body device is a predetermined data format,
a data format correction means for correcting, if it is determined that the data format of the moving-body device data is not the predetermined data format, the data format of the moving-body device data to the predetermined data format,
a feature extraction means for extracting feature information related to the moving-body device from the moving-body device data in the predetermined data format,
a state estimation means for estimating a state of the moving-body device using a trained model that uses the feature information extracted by the feature extraction means as input information and outputs state information indicating the state of the moving-body device related to the feature information,
a parameter calculation means for calculating an optimized parameter to be used by each of a plurality of control devices provided in the moving-body device based on the moving-body device data and the state information, and
a parameter update means for updating the parameter to be used by each of the plurality of control devices using the optimized parameter calculated by the parameter calculation means.

An update method according to the present disclosure includes,
by a computer,
determining whether a data format of moving-body device data that is data related to a moving-body device provided from the moving-body device is a predetermined data format,
correcting, if it is determined that the data format of the moving-body device data is not the predetermined data format, the data format of the moving-body device data to the predetermined data format,
extracting feature information related to the moving-body device from the moving-body device data in the predetermined data format,
estimating a state of the moving-body device using a trained model that uses the extracted feature information as input information and outputs state information indicating the state of the moving-body device related to the feature information,
calculating a parameter optimized using an algorithm that optimizes a parameter to be used by each of a plurality of control devices provided in the moving-body device, the moving-body device data, and the state information, and
updating the parameter to be used by each of the plurality of control devices using the calculated optimized parameter.

An update program according to the present disclosure causes
a computer to,
determine whether a data format of moving-body device data that is data related to a moving-body device provided from the moving-body device is a predetermined data format,
correct, if it is determined that the data format of the moving-body device data is not the predetermined data format, the data format of the moving-body device data to the predetermined data format,
extract feature information related to the moving-body device from the moving-body device data in the predetermined data format,
estimate a state of the moving-body device using a trained model that uses the extracted feature information as input information and outputs state information indicating the state of the moving-body device related to the feature information,
calculate a parameter optimized using an algorithm that optimizes a parameter to be used by each of a plurality of control devices provided in the moving-body device, the moving-body device data and the state information, and
update the parameter to be used by each of the plurality of control devices using the calculated optimized parameter.

An information processing device according to the present disclosure includes,
a data format determination means for determining whether a data format of moving-body device data that is data related to a moving-body device provided from the moving-body device is a predetermined data format,
a data format correction means for correcting, if it is determined that the data format of the moving-body device data is not the predetermined data format, the data format of the moving-body device data to the predetermined data format,
a feature extraction means for extracting feature information related to the moving-body device from the moving-body device data in the predetermined data format,
a state estimation means for estimating a state of the moving-body device using a trained model that uses the feature information extracted by the feature extraction means as input information and outputs state information indicating the state of the moving-body device related to the feature information,
a parameter calculation means for calculating a parameter optimized using an algorithm that optimizes a parameter to be used by each of a plurality of control devices provided in the moving-body device, the moving-body device data, and the state information, and
a parameter update instruction means for causing each of the plurality of control devices to update the parameter to be used by each of the plurality of control devices using the optimized parameter calculated by the parameter calculation means.

### Advantageous Effects of Invention

According to the present disclosure, it is possible to provide an update system, an update method, an update program, and an information processing device capable of updating an optimized parameter to be used by each of a plurality of control devices even in a case where the moving-body device includes a plurality of control devices and a plurality of pieces of data provided by the moving-body device do not have a common data format.

### BRIEF DESCRIPTION OF DRAWINGS

FIG. 1 is a diagram illustrating an example of an update system according to the present disclosure.

FIG. 2 is a diagram illustrating an example of a configuration of a moving-body device according to the present disclosure.

FIG. 3 is a diagram illustrating functions of an update control device according to the present disclosure.

FIG. 4 is a diagram illustrating a configuration of a management device according to the present disclosure.

FIG. 5 is a sequence diagram illustrating an example of a process executed in the update system according to the present disclosure.

FIG. 6 is a conceptual diagram illustrating a specific example of the update system.

FIG. 7 is a diagram illustrating details of a configuration of ontology.

FIG. 8 is a diagram illustrating an update procedure of ECUs.

FIG. 9 is a conceptual diagram illustrating a change in performance due to optimization of two ECUs manufactured by different manufacturers.

FIG. 10 is a diagram illustrating main components of an update system 1 according to the present disclosure.

### EXAMPLE EMBODIMENT

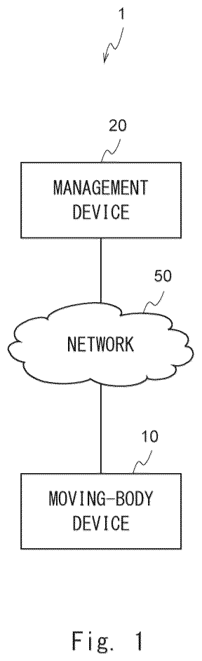

Hereinafter, illustrative example embodiments will be described with reference to the drawings. FIG. 1 is a diagram illustrating an example of an update system 1 according to the present disclosure. The update system 1 includes a moving-body device 10 and a management device 20. The moving-body device 10 and the management device 20 can communicate data with each other via a network 50. The network 50 includes a wide area network such as the Internet.

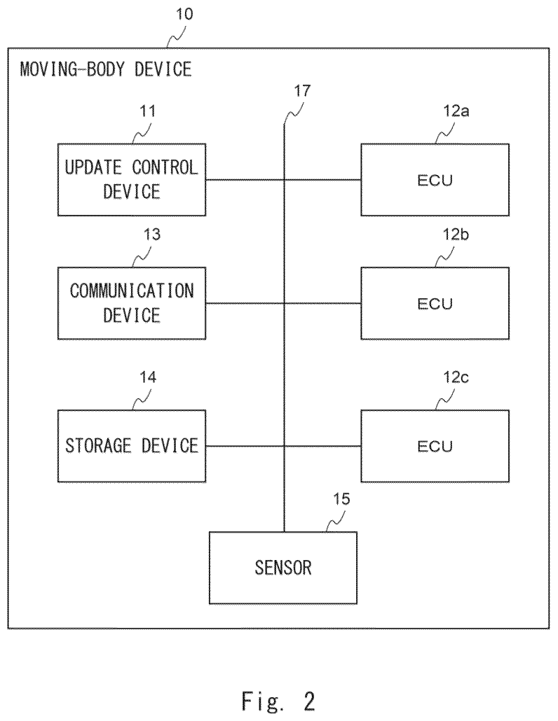

FIG. 2 is a diagram illustrating an example of a configuration of the moving-body device 10 according to the present disclosure. Specific examples of the moving-body device 10 include a vehicle such as an automobile and a flying object such as a drone. The moving-body device 10 includes an update control device 11, control devices 12a to 12c, a communication device 13, a storage device 14, and a sensor 15. The update control device 11, the control devices 12a to 12c, the communication device 13, the storage device 14, and the sensor 15 can perform data communication in accordance with a controller area network (CAN), a scalable service-oriented middleware over IP (SOME/IP), Ethernet, a time sensitive network (TSN), and the like via a network 17. The moving-body device 10 may include any number of control devices.

The update control device 11 is a device that controls updating of parameters used by the control devices 12a to 12c. Specific examples of the update control device 11 include various processors such as a central processing unit (CPU) and a micro processing unit (MPU), and integrated circuits such as a field-programmable gate array (FPGA) and an application specific integrated circuit (ASIC).

The control devices 12a to 12c are devices that control various devices provided in the moving-body device. Specific examples of the control devices 12a to 12c include electronic control units (ECUs) such as an engine control ECU, a motor control ECU, a brake control ECU, and a battery control ECU.

The communication device 13 is a device that communicates data with the management device 20 via the network 50. The storage device 14 stores a program executed by the update control device 11, and data such as information processed by the update control device 11.

The sensor 15 is a device that detects various types of information related to the moving-body device 10. Specific examples of the sensor 15 include a radar, a LiDAR, an imaging sensor, a temperature sensor, a speed sensor, an acceleration sensor, and the like.

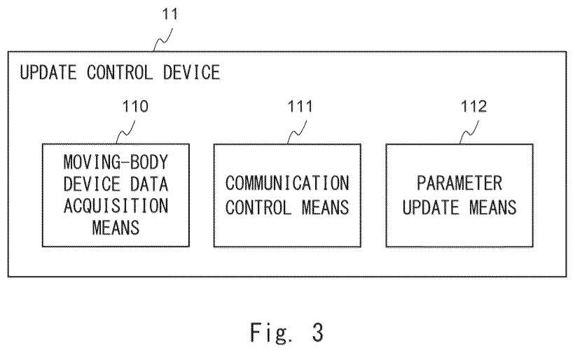

FIG. 3 is a diagram illustrating functions of the update control device 11. The update control device 11 includes a moving-body data acquisition means 110, a communication control means 111, and a parameter update means 112. The moving-body data acquisition means 110 is a program for acquiring data related to the moving-body device (hereinafter, referred to as “moving-body device data”.) from the control devices 12a to 12c and/or the sensor 15. The moving-body device data includes sensor information acquired by the sensor 15 and data acquired from the control devices 12a to 12c. The data acquired from the control devices 12a to 12c includes, for example, information indicating types of the control devices 12a to 12c, information indicating manufacturers of the control devices 12a to 12c, information indicating versions of software installed in the control devices 12a to 12c, bug reports related to hardware and/or software of the control devices 12a to 12c, and the like. The information indicating the types of the control devices 12a to 12c is, for example, types of ECUs such as an engine control ECU, a motor control ECU, a brake control ECU, and a battery control ECU.

The moving-body device data includes information indicating consumption of energy used by the moving-body device 10, for example, gasoline or diesel, biomass fuel, electricity, hydrogen, and the like, information indicating an emission amount of exhaust gas by the moving-body device 10, for example, nitrogen oxide, carbon dioxide, and the like, information indicating a cruising distance of the moving-body device 10, and information indicating performance of a power source provided in the moving-body device 10, for example, an engine, a motor, and the like. Such information can be acquired from the sensor 15 or the control devices 12a to 12c.

The communication control means 111 is a program for controlling data communication between the moving-body device 10 and the management device 20 by controlling the communication device 13. The communication control means 111 transmits the moving-body device data acquired from the control devices 12a to 12c to the management device 20. The communication control means 111 provides parameters received from the management device 20 to the control devices 12a to 12c.

The parameter update means 112 is a program for updating parameters used by the control devices 12a to 12c using the parameters received from the management device 20. The parameter update means 112 updates the parameters used by the control devices 12a to 12c at a specific timing according to safety and security policies. For example, the parameter update means 112 updates the parameters used by the control devices 12a to 12c in a case where the moving-body device 10 is idling or in a parking state.

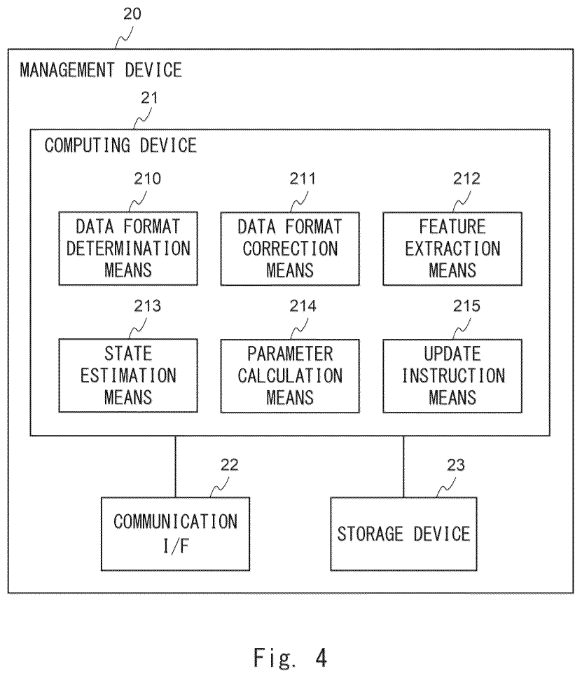

FIG. 4 is a diagram illustrating a configuration of the management device 20 according to the present disclosure. Specific examples of the management device 20 include an information processing device such as a server. The management device 20 includes a computing device 21, a communication interface (I/F) 22, and a storage device 23.

The computing device 21 is a device that performs overall control of the management device 20. Specific examples of the computing device 21 include integrated circuits such as various processors of CPU and MPU. A program executed by the computing device 21 may be executed by an integrated circuit such as FPGA or ASIC.

The communication interface 22 is a device that communicates data with the moving-body device 10 via the network 50. The storage device 23 stores the program executed by the computing device 21, and data such as information processed by the computing device 21.

The computing device 21 executes a data format determination means 210, a data format correction means 211, a feature extraction means 212, a state estimation means 213, a parameter calculation means 214, and an update instruction means 215.

The data format determination means 210 is a program for determining whether a data format of the moving-body device data received from the moving-body device 10 is a predetermined data format. Examples of the predetermined data format include a data format conforming to vehicle signal specification (VSS) or vehicle signal specification ontology (VSSO).

The data format correction means 211 is a program for correcting the data format of the moving-body device data received from the moving-body device 10 to a predetermined data format. Examples of the predetermined data format include a data format conforming to vehicle signal specification or vehicle signal specification ontology.

The feature extraction means 212 is a program for extracting feature information related to the moving-body device 10 from the moving-body device data in the predetermined data format. The feature information includes information indicating energy consumption by the moving-body device 10, information indicating an emission amount of exhaust gas by the moving-body device 10, information indicating a cruising distance of the moving-body device 10, information indicating performance of a power source of the moving-body device 10, and the like. The feature extraction means 212 can extract such feature information from a payload of the moving-body device data.

The state estimation means 213 is a program for estimating a state of the moving-body device 10 using the extracted feature information of the moving-body device data. The state estimation means 213 can estimate the state of the moving-body device 10 from the extracted feature information of the moving-body device data using a trained model trained by machine learning. The trained model can be trained with the moving-body device data as input information, and the information indicating the state of the moving-body device related to the moving-body device data as output information. The state estimation means 213 can obtain state information indicating the state of the moving-body device 10 related to the moving-body device data by inputting the moving-body device data received from the moving-body device 10 to the trained model. The state information indicating the state of the moving-body device 10 includes, for example, information indicating a time-series change in energy consumption by the moving-body device 10, information indicating a time-series change in an emission amount of exhaust gas by the moving-body device 10, information indicating a cruising distance of the moving-body device 10, information indicating a time-series change in performance of a power source of the moving-body device 10, and the like.

The parameter calculation means 214 is a program for calculating an optimized parameter set using an optimization algorithm that optimizes a parameter to be used by each of the plurality of control devices 12a to 12c provided in the moving-body device 10, moving-body device data provided from the moving-body device 10, and state information of the moving-body device 10. The parameter set includes a parameter related to consumption of energy used by the moving-body device 10, a parameter related to an emission amount of exhaust gas, a parameter related to a cruising distance, a parameter related to performance of a power source, and the like. Optimization of the parameter related to the consumption of energy is to derive a parameter that reduces a consumption amount of energy. Optimization of the parameter related to the emission amount of exhaust gas is to derive a parameter that reduces the emission amount of exhaust gas. Optimization of the parameter related to the cruising distance is to derive a parameter that increases the cruising distance. Optimization of the parameter related to performance of the power source is to derive a parameter that improves performance of the power source, for example, an output of the power source.

The parameter calculation means 214 can optimize the parameters using various optimization algorithms related to a type of the moving-body device 10, for example, a model of the vehicle. Specific examples of the optimization algorithm include an algorithm using a weighted average method, a genetic algorithm, and an algorithm using machine learning such as deep learning.

For example, in a case where the parameter is optimized using machine learning, the parameter calculation means 214 can obtain the optimized parameter of each control device using a model in which the moving-body device data provided from the moving-body device 10 and the state information of the moving-body device 10 calculated by the state estimation means 213 are used as input information and the optimized parameter set is used as output information. The model can be trained using moving-body device data and state information derived from the moving-body device data as input information, and using an optimized parameter set related to the moving-body device data and the state information as output information. The moving-body device data used for training the model includes information indicating the types of the control devices 12a to 12c, information indicating the manufacturers of the control devices 12a to 12c, information indicating the versions of the software installed in the control devices, bug reports related to the hardware and/or software of the control devices 12a to 12c, information indicating the consumption of the energy, information indicating the emission amount of the exhaust gas, information indicating the cruising distance, information indicating the performance of the power source, and the like. The parameter calculation means 214 can calculate the optimized parameter set using quantum computing.

The update instruction means 215 is a program for transmitting the calculated parameter set to the moving-body device 10 and updating the parameters to be used by the control devices 12a to 12c provided in the moving-body device 10.

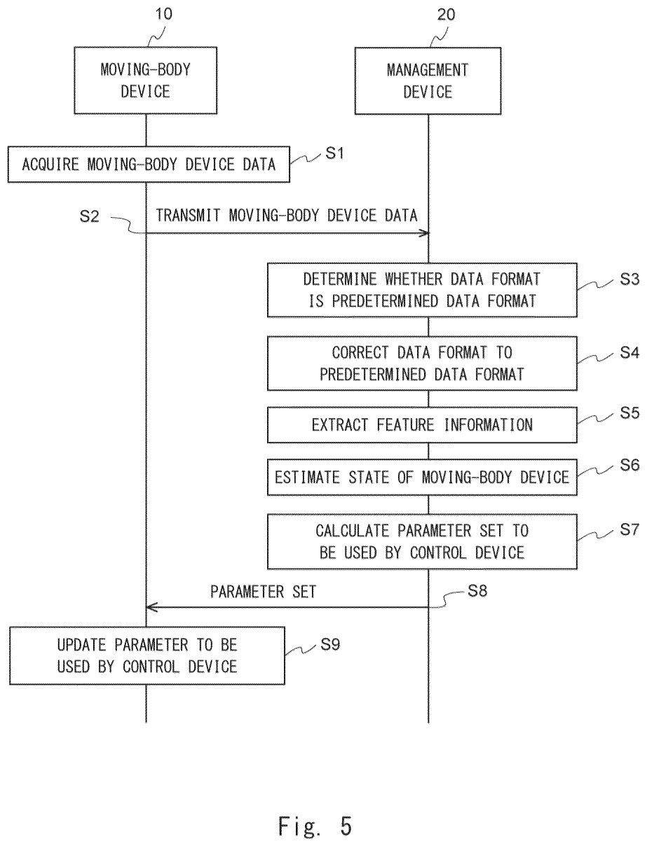

FIG. 5 is a sequence diagram illustrating an example of a process executed in the update system 1 according to the present disclosure.

In step S1, the moving-body data acquisition means 110 of the moving-body device 10 acquires the moving-body device data from each of the control devices 12a to 12c of the moving-body device 10. In step S2, the communication control means 111 of the moving-body device 10 transmits the acquired moving-body device data to the management device 20 via the network 50.

Once the management device 20 receives the moving-body device data from the moving-body device 10, the data format determination means 210 determines in step S3 whether the data format of the moving-body device data received from the moving-body device 10 is the predetermined data format.

If the data format of the moving-body device data received from the moving-body device 10 is not the predetermined data format, the data format correction means 211 corrects the data format of the moving-body device data received from the moving-body device 10 to the predetermined data format in step S4. If the data format of the moving-body device data received from the moving-body device 10 is the predetermined data format, the process of step S4 is not executed.

In step S5, the feature extraction means 212 extracts feature information of the moving-body device data received from the moving-body device 10.

In step S6, the state estimation means 213 estimates the state of the moving-body device 10 using the extracted feature information of the moving-body device data. The state estimation means 213 can estimate the state of the moving-body device 10 from the extracted feature information of the moving-body device data using a trained model trained by machine learning. The trained model can be trained with the moving-body device data as input information, and the information indicating the state of the moving-body device related to the moving-body device data as output information. The state estimation means 213 can obtain state information indicating the state of the moving-body device 10 related to the moving-body device data by inputting the moving-body device data received from the moving-body device 10 to the trained model.

In step S7, the parameter calculation means 214 calculates the parameter sets used by the plurality of control devices 12a to 12c of the moving-body device 10 using the moving-body device data received from the moving-body device 10 and the state information of the moving-body device 10. The parameter calculation means 214 adds identification information of the control devices 12a to 12c that use the parameters to each parameter included in the calculated parameter set.

In step S8, the update instruction means 215 transmits the calculated parameter set to the moving-body device 10.

In a case where the moving-body device 10 receives the parameter set from the management device 20, the parameter update means 112 of the moving-body device 10 updates the parameter of each of the plurality of control devices provided in the moving-body device 10 in step S9. Specifically, the parameter update means 112 specifies a control device to which the parameter is to be provided based on the identification information of the control devices 12a to 12c added to the parameter. Then, the parameter update means 112 provides and updates the parameter to the specified control device.

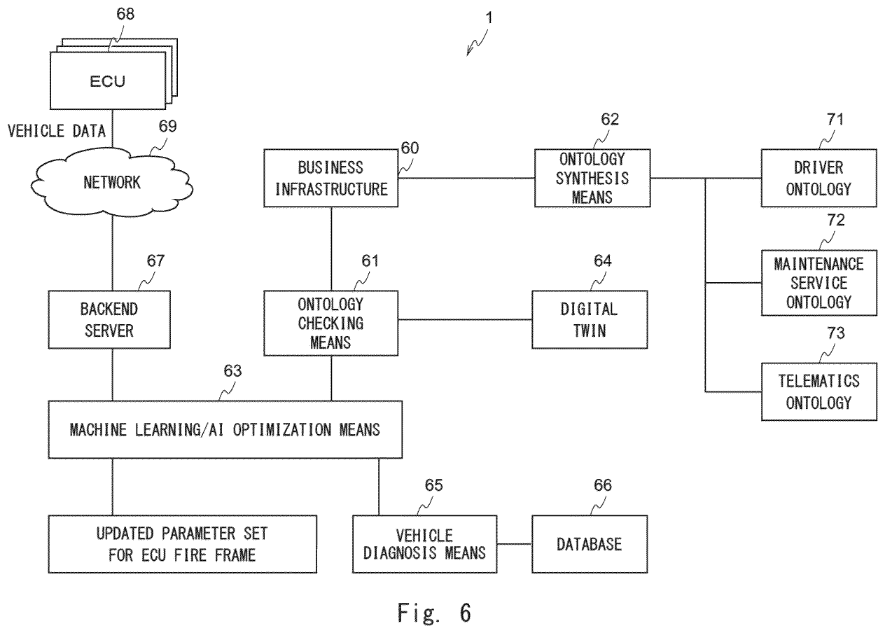

FIG. 6 is a conceptual diagram illustrating a specific example of the update system described above. In the example illustrated in FIG. 6, a vehicle is employed as the moving-body device 10. The update system 1 corresponds to a knowledge acquisition system.

A business infrastructure 60 provides access to an ontology checking means 61 and an ontology synthesis means 62.

The ontology checking means 61 corresponding to the data format determination means determines whether data provided to a machine learning (ML)/artificial intelligence (AI) optimization processing means 63 corresponding to the parameter calculation means 214 conforms to a predetermined data definition such as vehicle signal specification or vehicle signal specification ontology. The ontology checking means 61 also exchanges relevant vehicle data with a digital twin 64 including a vehicle twin or the like. A data set used by the digital twin 64 needs to conform to a predefined data set and data definition.

In the example illustrated in FIG. 6, a vehicle diagnosis means 65 executes vehicle diagnostic processing based on vehicle data. In the vehicle diagnosis processing, it is determined whether a state of the target vehicle meets manufacturer guidelines such as maximum power, energy consumption amount, functional safety, and security. Data sets and parameters related to vehicle state estimation are stored in a dedicated data server 66.

The ML/AI optimization processing means 63 executes ML/AI optimization processing on the parameter set of the control device. The ML/AI optimization processing means 63 finds a new parameter set and provides a data set for the updated parameter set to firmware of the control device.

A backend server 67 transmits the updated parameter set of an ECU 68 to a plurality of target ECUs 68 installed in the vehicle via a network 69. The plurality of ECUs 68 are updated by the updated parameter set of the ECU 68.

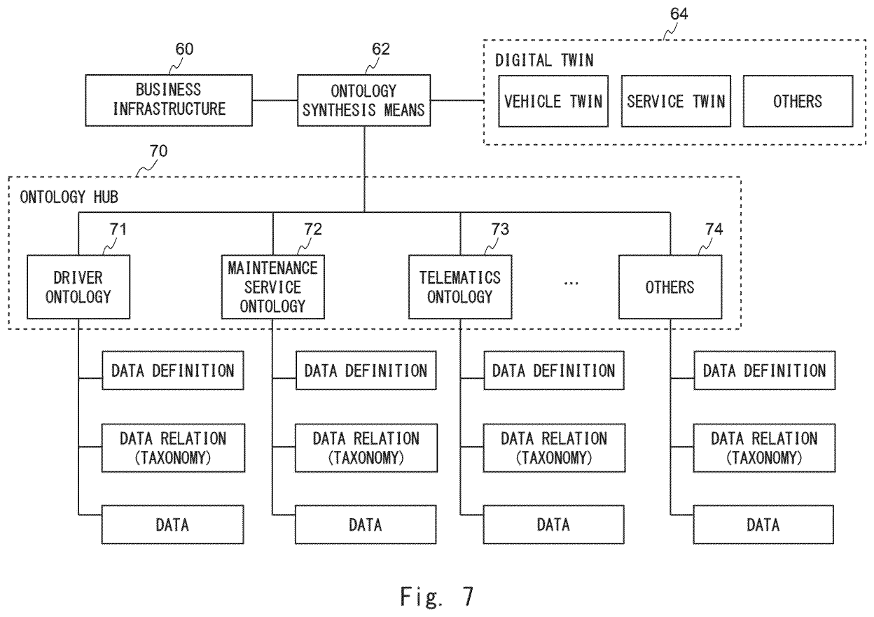

FIG. 7 is a diagram illustrating details of a configuration of ontology. The ontology synthesis means 62 is connected to the business infrastructure 60 and the digital twin 64 and provides a synthesis result. The result relates to a new data set for additional result data. Such result data relates to the digital twin.

The ontology synthesis means 62 combines a plurality of related ontologies via an ontology hub 70. The ontology hub 70 provides access to the plurality of related ontologies. The plurality of related ontologies includes a driver ontology 71, a maintenance service ontology 72, a telematics ontology 73, and other related ontologies 74. Each of the ontologies 71 to 74 includes data definition, data relation including data hierarchy, and data. The data definition and the data relation can be stored, for example, in a file in accordance with JSON or other XML. The data itself may be stored as a JSON file or other related file, for example, an XML file or a CSV file. The data can be read, compressed, and encrypted. If the data is encrypted, the system ensures that correct data definition and relation are supported.

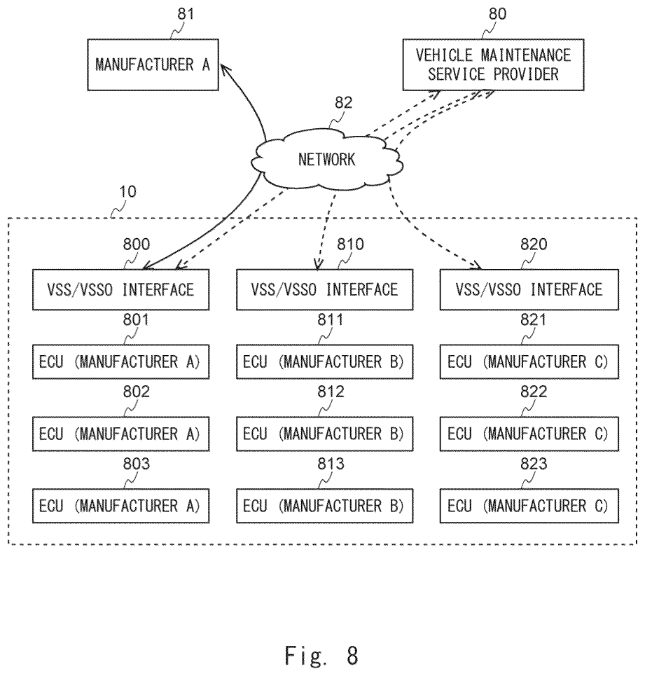

FIG. 8 is a diagram illustrating an update procedure of the ECUs. A manufacturer A 81 accesses only the ECUs 801 to 802 manufactured by the manufacturer A 81 via a network 82 and updates the parameter set as necessary.

Meanwhile, a vehicle maintenance service provider 80 accesses all of ECUs 801 to 803, 811 to 813, and 821 to 823 provided in a vehicle 10 via the network 82, and optimizes the ECUs at once as necessary. Here, VSS and VSSO interfaces 800, 810, and 820 support a simple method of updating the ECUs manufactured by different manufacturers.

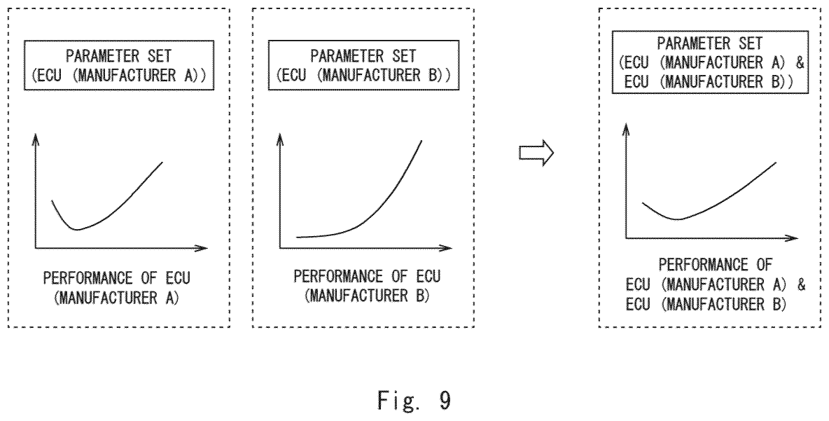

FIG. 9 is a conceptual diagram illustrating a change in performance due to optimization of two ECUs manufactured by different manufacturers. The left side of FIG. 9 illustrates a time change in performance in a case where the ECUs manufactured by different manufacturers are updated using an optimized parameter set. In the present disclosure, since the ECUs manufactured by different manufacturers can be updated, overall performance of two ECUs manufactured by different manufacturers can be improved as illustrated on the right side of FIG. 9.

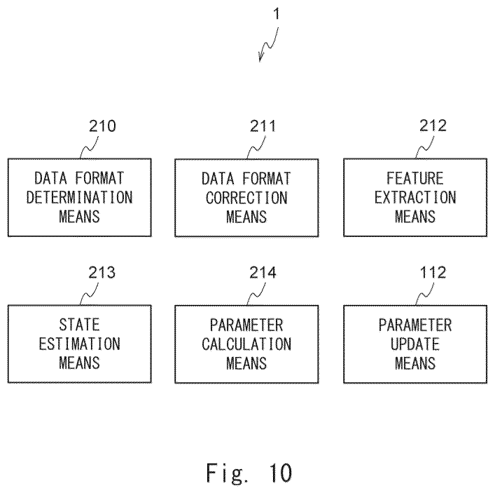

FIG. 10 is a diagram illustrating main components of the update system 1 according to the present disclosure. The update system 1 includes the data format determination means 210, the data format correction means 211, the feature extraction means 212, the state estimation means 213, the parameter calculation means 214, and the parameter update means 112. The data format determination means 210 determines whether the data format of the moving-body device data provided from the moving-body device 10 is the predetermined data format. If it is determined that the data format of the moving-body device data is not the predetermined data format, the data format correction means 211 corrects the data format of the moving-body device data to the predetermined data format. The feature extraction means 212 extracts the feature information related to the moving-body device from the moving-body device data in the predetermined data format. The state estimation means 213 estimates the state of the moving-body device 10 using a trained model that uses the feature information extracted by the feature extraction means 212 as input information and outputs the state information indicating the state of the moving-body device 10 related to the feature information. The parameter calculation means 214 calculates the optimized parameter based on the algorithm that optimizes the parameter to be used by each of the plurality of control devices 12a to 12c provided in the moving-body device 10, the moving-body device data, and the state information. The parameter update means 112 updates the parameter to be used by each of the plurality of control devices 12a to 12c using the optimized parameter calculated by the parameter calculation means 214.

By adopting such configuration, even in a case where the moving-body device 10 includes the plurality of control devices 12a to 12c and the plurality of pieces of data provided by the moving-body device are not in a common data format, the optimized parameter can be calculated based on the common data format. Then, the parameters used by each of the plurality of control devices 12a to 12c can be updated using the optimized parameter. For example, in a case where the moving-body device 10 includes the plurality of control devices 12a to 12c manufactured by different manufacturers, formats of data provided by the control devices 12a to 12c may be different. Even then, the update system 1 can optimize the parameters used by each of the plurality of control devices 12a to 12c.

In the example described above, the program includes a group of commands (or software codes) for causing a computer to execute one or more functions described in the example embodiments in a case where the program is read by the computer. The program may be stored in a non-transitory computer readable medium or a tangible storage medium. As an example and not by way of limitation, a computer readable medium or tangible storage medium includes a random-access memory (RAM), a read-only memory (ROM), a flash memory, a solid-state drive (SSD) or other memory technology, a CD-ROM, a digital versatile disk (DVD), a Blu-ray (registered trademark) disk, or other optical disk storages, a magnetic cassette, a magnetic tape, a magnetic disk storage, or other magnetic storage devices. The program may be transmitted on a transitory computer-readable medium or a communication medium. As an example and not by way of limitation, the transitory computer-readable medium or the communication medium includes an electric signal, an optical signal, an acoustic signal, or any other form of propagation signal. The processor and the server correspond to a computer.

The present disclosure is not limited to the example embodiments described above, and can be appropriately changed within a scope not deviating from the gist of the present disclosure. For example, in the above-described example embodiment, the management device 20 determines and corrects the data format of the moving-body device data, but in another example embodiment, the moving-body device 10 may include a data format determination means and a data format correction means.

Each drawing is merely illustrative for describing one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated or described. All of the features or steps illustrated in any one of the figures for describing illustrative example embodiments are not necessarily mandatory, and some features or steps may be omitted. The order of the steps described in any of the drawings may be changed as appropriate.

Some or all of the above-described example embodiments may be described as the following Supplementary Notes, but are not limited to the following Supplementary Notes.

### Supplementary Note 1

An update system including,
a data format determination means for determining whether a data format of moving-body device data that is data related to a moving-body device provided from the moving-body device is a predetermined data format,
a data format correction means for correcting, if it is determined that the data format of the moving-body device data is not the predetermined data format, the data format of the moving-body device data to the predetermined data format,
a feature extraction means for extracting feature information related to the moving-body device from the moving-body device data in the predetermined data format,
a state estimation means for estimating a state of the moving-body device using a trained model that uses the feature information extracted by the feature extraction means as input information and outputs state information indicating the state of the moving-body device related to the feature information,
a parameter calculation means for calculating a parameter optimized using an algorithm that optimizes a parameter to be used by each of a plurality of control devices provided in the moving-body device, the moving-body device data, and the state information, and
a parameter update means for updating the parameter to be used by each of the plurality of control devices using the optimized parameter calculated by the parameter calculation means.

### Supplementary Note 2

The update system according to supplementary note 1, wherein the predetermined data format is a data format conforming to vehicle signal specification or vehicle signal specification ontology.

### Supplementary Note 3

The update system according to supplementary note 1 or 2, wherein the feature information includes information indicating energy consumption by the moving-body device, information indicating an emission amount of exhaust gas by the moving-body device, information indicating a cruising distance of the moving-body device, and information indicating performance of a power source provided in the moving-body device.

### Supplementary Note 4

The update system according to any one of supplementary notes 1 to 3, wherein the parameter calculation means calculates the optimized parameter using a trained model that uses the moving-body device data and the state information as input information and the optimized parameter as output information.

### Supplementary Note 5

The update system according to any one of supplementary notes 1 to 4, wherein the moving-body device data includes information indicating a type of the control device, information indicating a manufacturer of the control device, information indicating a version of software installed in the control device, a bug report related to the control device, and the feature information.

### Supplementary Note 6

An update method including,
by a computer,
determining whether a data format of moving-body device data that is data related to a moving-body device provided from the moving-body device is a predetermined data format,
correcting, if it is determined that the data format of the moving-body device data is not the predetermined data format, the data format of the moving-body device data to the predetermined data format,
extracting feature information related to the moving-body device from the moving-body device data in the predetermined data format,
estimating a state of the moving-body device using a trained model that uses the extracted feature information as input information and outputs state information indicating the state of the moving-body device related to the feature information,
calculating a parameter optimized using an algorithm that optimizes a parameter to be used by each of a plurality of control devices provided in the moving-body device, the moving-body device data, and the state information, and
updating the parameter to be used by each of the plurality of control devices using the calculated optimized parameter.

### Supplementary Note 7

The update method according to supplementary note 6, wherein the predetermined data format is a data format conforming to vehicle signal specification or vehicle signal specification ontology.

### Supplementary Note 8

The update method according to supplementary note 6 or 7, wherein the feature information includes information indicating energy consumption by the moving-body device, information indicating an emission amount of exhaust gas by the moving-body device, information indicating a cruising distance of the moving-body device, and information indicating performance of a power source provided in the moving-body device.

### Supplementary Note 9

The update method according to supplementary note 8, wherein the computer performs calculation using a trained model that uses the moving-body device data and the state information as input information and the optimized parameter as output information.

### Supplementary Note 10

The update method according to supplementary note 9, wherein the moving-body device data includes information indicating a type of the control device, information indicating a manufacturer of the control device, information indicating a version of software installed in the control device, a bug report related to the control device, and the feature information.

### Supplementary Note 11

An update program causing a computer to,
determine whether a data format of moving-body device data that is data related to a moving-body device provided from the moving-body device is a predetermined data format,
correct, if it is determined that the data format of the moving-body device data is not the predetermined data format, the data format of the moving-body device data to the predetermined data format,
extract feature information related to the moving-body device from the moving-body device data in the predetermined data format,
estimate a state of the moving-body device using a trained model that uses the extracted feature information as input information and outputs state information indicating the state of the moving-body device related to the feature information,
calculate a parameter optimized using an algorithm that optimizes a parameter to be used by each of a plurality of control devices provided in the moving-body device, the moving-body device data and the state information, and
update the parameter to be used by each of the plurality of control devices using the calculated optimized parameter.

### Supplementary Note 12

The update program according to supplementary note 11, wherein the predetermined data format is a data format conforming to vehicle signal specification or vehicle signal specification ontology.

### Supplementary Note 13

The update program according to supplementary note 11 or 12, wherein the feature information includes information indicating energy consumption by the moving-body device, information indicating an emission amount of exhaust gas by the moving-body device, information indicating a cruising distance of the moving-body device, and information indicating performance of a power source provided in the moving-body device.

### Supplementary Note 14

The update program according to supplementary note 13, further causing the computer to calculate the optimized parameter using a trained model that uses the moving-body device data and the state information as input information and the optimized parameter as output information.

### Supplementary Note 15

The update program according to supplementary note 14, wherein the moving-body device data includes information indicating a type of the control device, information indicating a manufacturer of the control device, information indicating a version of software installed in the control device, a bug report related to the control device, and the feature information.

### Supplementary Note 16

An information processing device including,
a data format determination means for determining whether a data format of moving-body device data that is data related to a moving-body device provided from the moving-body device is a predetermined data format,
a data format correction means for correcting, if it is determined that the data format of the moving-body device data is not the predetermined data format, the data format of the moving-body device data to the predetermined data format,
a feature extraction means for extracting feature information related to the moving-body device from the moving-body device data in the predetermined data format,
a state estimation means for estimating a state of the moving-body device using a trained model that uses the feature information extracted by the feature extraction means as input information and outputs state information indicating the state of the moving-body device related to the feature information,
a parameter calculation means for calculating a parameter optimized using an algorithm that optimizes a parameter to be used by each of a plurality of control devices provided in the moving-body device, the moving-body device data, and the state information, and
a parameter update instruction means for causing each of the plurality of control devices to update the parameter to be used by each of the plurality of control devices using the optimized parameter calculated by the parameter calculation means.

### Supplementary Note 17

The information processing device according to supplementary note 16, wherein the predetermined data format is a data format conforming to vehicle signal specification or vehicle signal specification ontology.

### Supplementary Note 18

The information processing device according to supplementary note 16 or 17, wherein the feature information includes information indicating energy consumption by the moving-body device, information indicating an emission amount of exhaust gas by the moving-body device, information indicating a cruising distance of the moving-body device, and information indicating performance of a power source provided in the moving-body device.

### Supplementary Note 19

The information processing device according to supplementary note 18, wherein the parameter calculation means calculates the optimized parameter using a trained model that uses the moving-body device data and the state information as input information and the optimized parameter as output information.

### Supplementary Note 20

The information processing device according to supplementary note 19, wherein the moving-body device data includes information indicating a type of the control device, information indicating a manufacturer of the control device, information indicating a version of software installed in the control device, a bug report related to the control device, and the feature information.

This application is based upon and claims the benefit of priority from Japanese patent application No. 2023-59771, filed on Apr. 3, 2023, the disclosure of which is incorporated herein in its entirety by reference.

### REFERENCE SIGNS LIST

1 update system
10 moving-body device, vehicle
11 update control device
12a control device
12b control device
12c control device
13 communication device
14 storage device
15 sensor
17 network
20 management device
21 computing device
22 communication interface
23 storage device
110 moving-body data acquisition means
111 communication control means
112 parameter update means
210 data format determination means
211 data format correction means
212 feature extraction means
213 state estimation means
214 parameter calculation means
215 update instruction means

What is claimed is:

1. An update system comprising:
at least one memory configured to store instructions; and
at least one processor configured to execute the instructions to:
determine whether a data format of moving-body device data that is data related to a moving-body device provided from the moving-body device is a predetermined data format;
correct, if it is determined that the data format of the moving-body device data is not the predetermined data format, the data format of the moving-body device data to the predetermined data format;
extract feature information related to the moving-body device from the moving-body device data in the predetermined data format;
estimate a state of the moving-body device using a trained model that uses the feature information extracted as input information and outputs state information indicating the state of the moving-body device related to the feature information;
calculate a parameter optimized using an algorithm that optimizes a parameter to be used by each of a plurality of control devices provided in the moving-body device, the moving-body device data, and the state information; and
update the parameter to be used by each of the plurality of control devices using the optimized parameter.

2. The update system according to claim 1, wherein the predetermined data format is a data format conforming to vehicle signal specification or vehicle signal specification ontology.

3. The update system according to claim 1, wherein the feature information includes information indicating energy consumption by the moving-body device, information indicating an emission amount of exhaust gas by the moving-body device, information indicating a cruising distance of the moving-body device, and information indicating performance of a power source provided in the moving-body device.

4. The update system according to claim 3, wherein the at least one processor configured to execute the instructions to calculate the optimized parameter using a trained model that uses the moving-body device data and the state information as input information and the optimized parameter as output information.

5. The update system according to claim 4, wherein the moving-body device data includes information indicating a type of the control device, information indicating a manufacturer of the control device, information indicating a version of software installed in the control device, a bug report related to the control device, and the feature information.

6. A computer implemented update method comprising:
determining whether a data format of moving-body device data that is data related to a moving-body device provided from the moving-body device is a predetermined data format;
correcting, if it is determined that the data format of the moving-body device data is not the predetermined data format, the data format of the moving-body device data to the predetermined data format;
extracting feature information related to the moving-body device from the moving-body device data in the predetermined data format;
estimating a state of the moving-body device using a trained model that uses the extracted feature information as input information and outputs state information indicating the state of the moving-body device related to the feature information;
calculating a parameter optimized using an algorithm that optimizes a parameter to be used by each of a plurality of control devices provided in the moving-body device, the moving-body device data, and the state information; and
updating the parameter to be used by each of the plurality of control devices using the calculated optimized parameter.

7. The method according to claim 6, wherein the predetermined data format is a data format conforming to vehicle signal specification or vehicle signal specification ontology.

8. The method according to claim 6, wherein the feature information includes information indicating energy consumption by the moving-body device, information indicating an emission amount of exhaust gas by the moving-body device, information indicating a cruising distance of the moving-body device, and information indicating performance of a power source provided in the moving-body device.

9. The method according to claim 8, wherein the computer performs calculation using a trained model that uses the moving-body device data and the state information as input information and the optimized parameter as output information.

10. The method according to claim 9, wherein the moving-body device data includes information indicating a type of the control device, information indicating a manufacturer of the control device, information indicating a version of software installed in the control device, a bug report related to the control device, and the feature information.

11. Non-transitory recording medium storing an update program causing a computer to:
determine whether a data format of moving-body device data that is data related to a moving-body device provided from the moving-body device is a predetermined data format;
correct, if it is determined that the data format of the moving-body device data is not the predetermined data format, the data format of the moving-body device data to the predetermined data format;
extract feature information related to the moving-body device from the moving-body device data in the predetermined data format;
estimate a state of the moving-body device using a trained model that uses the extracted feature information as input information and outputs state information indicating the state of the moving-body device related to the feature information;
calculate a parameter optimized using an algorithm that optimizes a parameter to be used by each of a plurality of control devices provided in the moving-body device, the moving-body device data, and the state information; and
update the parameter to be used by each of the plurality of control devices using the calculated optimized parameter.

12. The non-transitory recording medium according to claim 11, wherein the predetermined data format is a data format conforming to vehicle signal specification or vehicle signal specification ontology.

13. The non-transitory recording medium according to claim 11, wherein the feature information includes information indicating energy consumption by the moving-body device, information indicating an emission amount of exhaust gas by the moving-body device, information indicating a cruising distance of the moving-body device, and information indicating performance of a power source provided in the moving-body device.

14. The non-transitory recording medium according to claim 13, wherein the program further causes the computer to calculate the optimized parameter using a trained model that uses the moving-body device data and the state information as input information and the optimized parameter as output information.

15. The non-transitory recording medium according to claim 14, wherein the moving-body device data includes information indicating a type of the control device, information indicating a manufacturer of the control device, information indicating a version of software installed in the control device, a bug report related to the control device, and the feature information.

16-20. (canceled)
